(19) United States
(12) Patent Application Publication
(10) Pub. No.: US 2011/0146370 A1
(43) Pub. Date: Jun. 23, 2011

(54) SENSOR HAVING AN INTERNAL CALIBRATION STRUCTURE

(75) Inventor: Josef Glaser, Graz (AT)

(73) Assignee: Kistler Holding AG, Winterthur (CH)

(21) Appl. No.: 13/059,665

(22) PCT Filed: Aug. 19, 2009
(86) PCT No.: PCT/EP09/06005

§ 371 Date: Feb. 18, 2011

(30) Foreign Application Priority Data
Aug. 19, 2008 (AT) A 1286/2008

(51) Int. Cl. G01L 27/00; G01L 7/16

(52) U.S. Cl. 73/1.57; 73/744

(57) ABSTRACT

A sensor has a measuring element that measures forces. The measuring element measures direct forces or measurement variables which are converted into forces by means of a measurement variable converter in the sensor. The sensor includes a structure that converts test pressure guided into the sensor into a test force that stresses the measuring element in the same manner as the phenomenon that is to be measured by the sensor.

### CROSS-REFERENCE TO RELATED APPLICATIONS

This application claims priority to International Application Serial No. PCT/EP2009/006005 filed Aug. 19, 2009, which claims priority to Austrian Application No. AT 1286/2008 filed Aug. 19, 2008.

### TECHNICAL FIELD

The invention relates to a sensor in which the value to be measured is a force or a value such as for example acceleration or path which is converted by means of components of the sensor into force, the measuring element, which is the element forming the measurement signals, in each case converting this force into the measurement signal, it being possible for the nature of the reaction to this force to vary very widely, e.g. charge output, voltage change, displacement, etc., or sensors which must be calibrated during operation.

### BACKGROUND

There are many sensors in which the value to be measured exerts a force on the measuring element of the sensor. For the most part, force sensors conduct the value to be measured directly to the measuring element, but also in pressure, acceleration, movement or torque sensors, the measuring element is ultimately loaded by a force which is proportional to the value to be measured.

Many of these sensors are provided for long-term use for example for monitoring tasks and it would be desirable to be able to test their functionality from time to time. For the most part, this takes place by means of the application of a known load from outside, which is for the most part complex and in some cases impossible, because for example, the sensors are not accessible to such a test load without disassembly.

### OBJECT AND SUMMARY OF THE INVENTION

The object for the present invention therefore consisted in finding a testing option or a calibration option for the function of sensors of this type, which option makes it possible, without disassembly of the sensor, to the greatest possible extent without interrupting the measurement function and without expensive additional apparatus, to check the state of the sensor at any time.

The object is achieved by means of the equipping of the sensor with a test structure or a calibration structure which converts a test pressure or calibration pressure, which is conducted into the sensor by means of a pressure-transmitting fluid, gas or liquid, into a test or calibration force acting on the measuring element.

In particular, the object is achieved by means of the features of the claims.

The term test apparatus used below also incorporates the term calibration apparatus. Consequently, the meaning as calibration pressure also applies to test pressure of the test medium.

The test structure includes a piston loaded with test pressure, which is supported on the measuring element, it also being possible for other sensor areas to be sealed with respect to the test pressure, for example by means of a membrane. The test pressure is conveyed onto the piston in the sensor by means of a pressure line, a connection to an external pressure source ideally taking place in that the pressure line of the sensor and a line coming from an external pressure source and arranged in the assembly point meet in an assembly area, so that the connection of the pressure lines is also produced by means of the sensor assembly.

This test force can be laid over the continuously detected measurement signal as a test pulse, for example as a rectangle or triangle, so that the actual measurement of the sensor does not have to be interrupted. Changes of the sensor behaviour are measured and can be used for testing or recalibrating the sensor. In any case, the contact to the value to be measured is not disturbed and never interrupted by means of the inner test load additionally applied to the measuring element, that is to say, the testing or calibration takes place during continuous uninterrupted measurement.

Disassembly of the sensor for testing or calibration of the sensor therefore remain unnecessary.

### BRIEF DESCRIPTION OF THE DRAWINGS

The FIGS. 1 to 3 show acceleration sensors with integrated calibration structure according to the invention

FIG. 4 shows a force sensor according to the invention

FIG. 5 shows a path sensor according to the invention

FIG. 6 shows a slowly changing force signal which is overlaid by a test pulse

FIG. 7 shows a rapidly changing signal with a comparatively slow test pulse

### DETAILED DESCRIPTION OF EXEMPLARY EMBODIMENTS

The sensor in FIG. 1 is configured for integration into an assembly point 1 which, in addition to a fixing thread 2 also has an inflow hole 3a for the pressure-transmitting medium or the test pressure. From this inflow hole, the pressure medium producing the test pressure is conveyed via the assembly gap 4, which is sealed by means of two O-rings 5, into the sensor, next into the annular channel 3b and then via the short hole 3c to the piston 6. The annular channel 3b has the advantage that the inflow hole 3a may open at any desired point on the annular channel circumference. The measurement mass 15 in this example acts as a pressure piston 11 and as force introduction 6 for the measuring element 7. By loading the pressure piston/measurement mass/pressure introduction part with the test pressure, a test pressure is generated on the measuring element 7. A sealing membrane 8 seals the measuring element 7 against disturbances caused by the pressure medium.

In FIG. 2, a similar acceleration sensor is shown, whereby in turn, the measurement mass 15 is used as pressure piston 11 and force introduction part 6, but the sealing membrane 8 acts on the upper edge of the measurement mass. The test pressure supply takes place at the assembly area 10 of the sensor by means of a supply channel 3a in the assembly point opposite the hole in the sensor 3c.

In the sensor according to FIG. 3, the test force produced by the piston 11 and adjacent sealing membrane 8 at the assembly end of the sensor is guided via a force transmitting element 12 to the measurement mass 15 and thus to the measuring element 7.

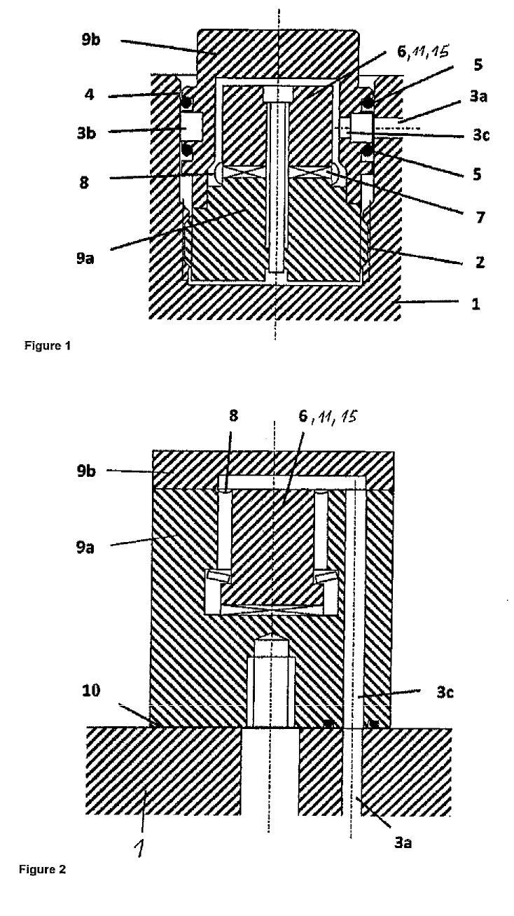

FIG. 4 shows a force sensor which has the same test structure for calibrating the force measuring element contained therein as the acceleration sensor according to FIG. 3.

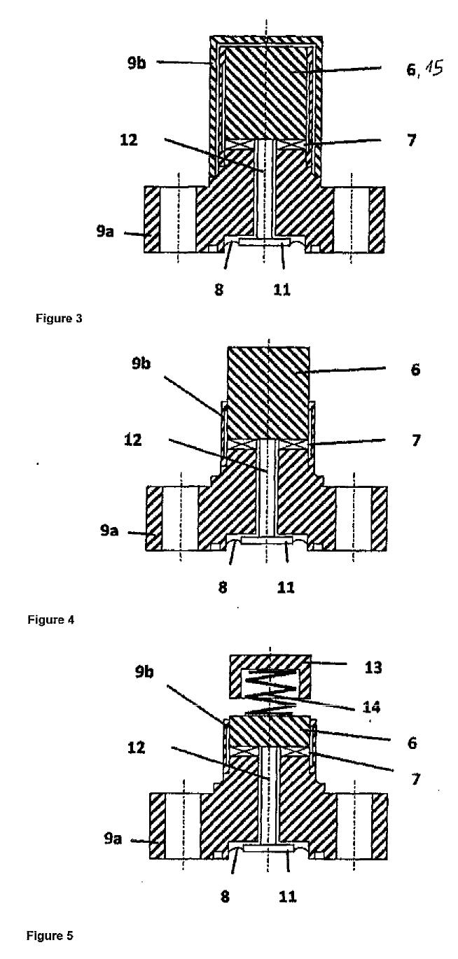

FIG. 5 shows a path sensor which has the same test structure for calibrating the force measuring element contained therein as the acceleration sensor according to FIG. 3.

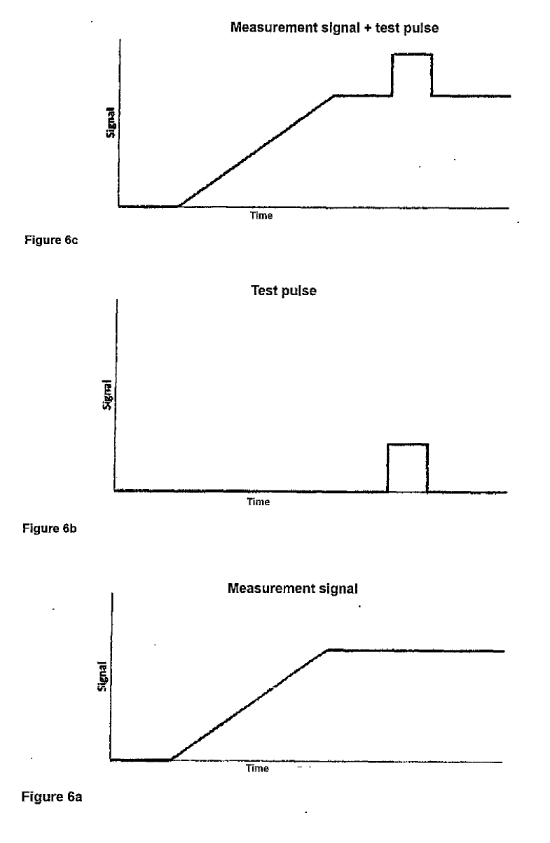

FIG. 6a by way of example shows a signal curve of the measurement signal, which changes relatively slowly over time. If this curve is overlaid by a test pulse according to FIG. 6b, then an overall measured curve (FIG. 6c) made up of the sum of these two signals, both the height of the test pulse and how large the signal caused by it has to be, that is to say how large the signal change brought about by the test or calibration pulse must be, being known.

If the height of the measured signal change at the measuring element does not match that expected, one can conclude faulty behaviour of the measuring element or change the calibration constant for the measuring element in such a manner that the measurement signal expected for the test pulse appears at the correct height once more. The test pulse ideally has at least one very steep side, so that the evaluation of the measurement signal change caused by the test pulse is also still possible on measurement signals with clear gradients.

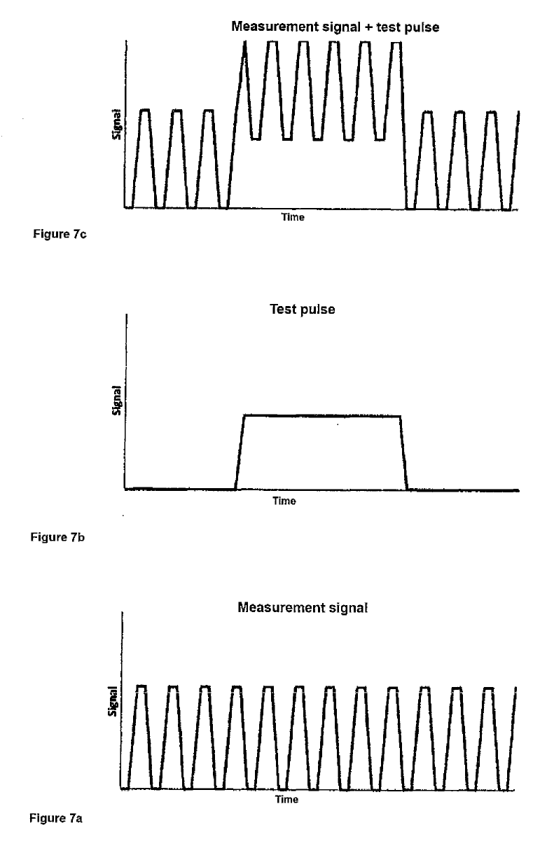

FIG. 7a by way of example shows a very rapid periodically changing measurement signal, at the steep sides of which even extremely rapid test pulses can no longer be discerned with sufficient precision. In this case, a test pulse (FIG. 7b) of such a type that over a series of the periodic signal pulses of the signal to be measured, their level is changed (FIG. 7c) and one can compare the change of this level with the setpoint height of the test pulse, or a periodically changing test pressure curve, the frequency of which is substantially smaller than the frequency of the actual measurement signal, is used.

1. A sensor with integrated test apparatus for the direct measurement of forces, which has a housing, a force-measuring measuring element and a force-introducing part, wherein the force-measuring measuring element of the sensor is connected to a pressure piston directly or via a force-transmitting part, wherein the pressure piston is sealed with respect to the housing of the sensor, and wherein an inflow hole for test medium is present in the sensor or in an assembly point connected in a pressure-tight manner to the sensor or in both, wherein this test medium guides test pressure to the pressure piston and thus an additional test signal, laid over the actual measurement signal during the measurement, is generated at the measuring element in the form of an additional test force.

2. The sensor for the indirect measurement of measured values, such as for example accelerations or path changes, which are converted by means of components of the sensor into forces, and can therefore be measured indirectly with a force-measuring measuring element, wherein the sensor has a housing, a force-measuring measuring element, a force-introducing part and a measured value converter (14), which converts the actual measured values into a force, wherein the indirectly measured values are e.g. an acceleration which is converted by means of a measurement mass connected to the measuring element into a force, or a path change which is converted by means of an elastic part connected to the measuring element into a force signal, wherein the force-measuring measuring element of the sensor is connected directly or via a force-transmitting part to a pressure piston, wherein the pressure piston is sealed with respect to the housing of the sensor, and wherein an inflow hole for test medium is present in at least one of the sensor or an assembly point connected in a pressure-tight manner to the sensor, wherein this test medium guides test pressure to the pressure piston and thus an additional test signal, laid over the actual measurement signal during the measurement, is generated at the measuring element in the form of an additional test force.

3. The sensor according to claim 1, wherein a narrow gap is defined between the pressure piston and the housing.

4. The sensor according to claim 1, wherein an elastic membrane defines a seal between the pressure piston and the housing.

5. The sensor according to claim 1, wherein the inflow hole for the test medium in the sensor leads into an assembly area of the sensor and in that a pressure supply line arranged at the assembly point of the sensor leads to the same point of the assembly area as the inflow hole, so that the connection of the inflow holes is also produced by means of the sensor assembly.

6. A method for the testing or calibration of sensors, with a measuring element, which converts force into the sensor output signal, wherein the sensor remains integrated at its use location during the testing, the method comprising:
generating a calibration signal by means of a pressure pulse which is conveyed by means of a pressure medium through an inflow hole into the interior of the sensor, wherein the calibration signal generated therewith is laid over the actual measurement signal during continuous measurement.

7. The method according to claim 6, wherein the signal curve of the calibration signal has steeper signal sides than the signal curve of the measurement signal so that the calibration signal can readily be recognised as overlay for the measurement signal and thus, the height of the overlaid pulse in the measurement signal can be evaluated well.

8. The method according to claim 6, wherein the test signal offers periods with substantially constant signal value, preferably in the form of very long rectangular pulses, a single change of the pressure level or in the form of a periodically changing test pressure curve, the frequency of which is substantially smaller than the frequency of the actual measurement signal and which make it possible to compare the values of a temporally rapidly changing measurement signal averaged in these periods with the test signal acting there.

9. The sensor according to claim 2, wherein a narrow gap is defined between the pressure piston and the housing.

10. The sensor according to claim 2, wherein an elastic membrane defines a seal between the pressure piston and the housing.

11. The sensor according to claim 2, wherein the inflow hole for the test medium in the sensor leads into an assembly area of the sensor and in that a pressure supply line arranged at the assembly point of the sensor leads to the same point of the assembly area as the inflow hole, so that the connection of the inflow holes is also produced by means of the sensor assembly.
